(19) United States
(12) Patent Application Publication
(10) Pub. No.: US 2026/0321625 A1
(43) Pub. Date: Oct. 15, 2026

(54) SURFACE-TREATED NEGATIVE ELECTRODES FOR SODIUM-ION BATTERIES

(71) Applicant: U.S. Army DEVCOM, Army Research Laboratory, Adelphi, MD (US)

(72) Inventors: Glenn R. Pastel, Silver Spring, MD (US); Jeffrey A. Read, West Friendship, MD (US); Marshall A. Schroeder, Pasadena, MD (US); Travis P. Pollard, Rockville, MD (US); Oleg A. Borodin, Laurel, MD (US)

(73) Assignee: U.S. Government, as Represented by the Secretary of the Army, Adelphi, MD (US)

(21) Appl. No.: 19/554,019

(22) Filed: Mar. 2, 2026

Related U.S. Application Data
(60) Provisional application No. 63/787,361, filed on Apr. 11, 2025.

(51) Int. Cl. H01M 4/57; H01M 4/02; H01M 4/04; H01M 10/054; H01M 10/0567; H01M 10/0569

(52) U.S. Cl. CPC H01M 4/57; H01M 4/0416; H01M 10/054; H01M 10/0567; H01M 10/0569; H01M 2004/027

(57) ABSTRACT

Provided is a surface treatment process to dictate the surface chemistry of a negative electrode for sodium-ion batteries. In particular, the surface treatment process eliminates and, in some instances, replaces the native oxide of the alloy-type negative electrode material with more favorable amounts of species, such as PbCl₂ or PbF₂, derived from the acid etch composition. The surface treatment process may include a washing step with a solution composition tailored to the surface chemistry after the acid etching step. The initial Coulombic efficiency and utilization of the active material in the surface-treated negative electrode is above 90%, relative to the theoretical maximum, for both metrics. Specific classes of solvents need to be avoided and used to enable the surface-treated negative electrode. These results indicate that engineering the surface chemistry of an alloy material enables a new class of negative electrode active materials for sodium-ion batteries.

### CROSS-REFERENCE TO RELATED APPLICATIONS

The present application claims priority to U.S. Provisional Patent Application No. 63/787,361 filed Apr. 11, 2025, the contents of which are herein incorporated by reference in its entirety.

### GOVERNMENT INTEREST

The invention described herein may be manufactured, used and licensed by or for the U.S. Government for all governmental purposes without the payment of royalties thereon.

### BACKGROUND OF THE INVENTION

### Field

Embodiments of the present disclosure are directed to battery chemistry and, more particularly, to a surface modification process for preparing a negative electrode for sodium-ion batteries.

### Description of Related Art

Sodium-ion batteries are an emerging complement to rechargeable lithium-ion batteries, which leverage inexpensive crude materials and achieve similar or better performance metrics. Sodium-ion batteries currently use a negative electrode composed of hard carbon as the active material. Hard carbon suffers from high first-cycle capacity losses, sodium metal plating during extended use, and batch-to-batch inconsistency of its material properties. The overall cost of the crude material also tends to be higher than natural and synthetic graphite for lithium-ion batteries, an alternative energy storage solution. As a result, state-of-the-art sodium-ion batteries are not yet cost-competitive with lithium-ion batteries ($/kWh) and have low energy densities (~100 Wh/kg, cell-level). For rechargeable sodium-ion batteries to achieve greater market penetration, negative electrodes with better performance must be developed.

Alloy-based negative electrodes are an appealing replacement for carbon-based active materials in sodium-ion batteries to reduce cost and improve energy density. However, issues associated with anode utilization, reversibility, and volume expansion limit their adoption. More specifically, the group 14 elements lead (Pb) and tin (Sn) are the most promising alloy materials for sodium-ion negative electrodes due to their high gravimetric capacity (485 and 847 mAh g⁻¹, respectively), high volumetric capacity (1072 and 1108 mAh cm⁻³, respectively), low alloying potentials, and high natural abundance. Therefore, innovations specific to these alloy-based negative electrodes for sodium-ion batteries are highly desired.

### BRIEF SUMMARY OF THE INVENTION

In view of the foregoing, an embodiment herein provides a sodium-ion battery cell comprising a negative electrode containing a group 14 metal, such as lead (Pb), as the active material. The active material undergoes a surface treatment process, primarily involving acid etching, to remove the native oxide layer. The battery cell also includes a positive electrode and a compatible ether-based electrolyte. Another embodiment provides a method for manufacturing a negative electrode comprising active material. The active material may comprise a group 14 element or an alloy thereof and a native oxide layer. A surface treatment is applied to the active material, the surface treatment may comprise an acid etching step wherein the active material is immersed in an acid etching solution for a predetermined duration to remove at least a portion of the native oxide layer.

These and other aspects of the embodiments herein will be better appreciated and understood when considered in conjunction with the following description and the accompanying drawings. It should be understood, however, that the following descriptions, while indicating exemplary embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

FIG. 1 is a schematic illustration of a sodium-ion battery with an alloy-based negative electrode, according to an embodiment herein.

FIGS. 2A and 2B are photographs of surface-treated lead alloy negative electrodes, according to an embodiment herein.

FIGS. 3A, 3B, 3C, and 3D are X-ray photoelectron spectra of the Pb4f, O1s, Cl2p, and F1s bands of four negative electrodes for sodium-ion batteries after different surface treatments, according to an embodiment herein.

FIGS. 4A and 4B are X-ray diffraction spectra of four negative electrodes for sodium-ion batteries after different surface treatments, according to an embodiment herein.

FIG. 5 is the voltage profile of a surface-treated lead negative electrode in a half cell with ether-based electrolyte, according to an embodiment herein.

FIG. 6 shows the voltage profile of a surface-treated lead negative electrode in a half cell with ether-based electrolyte over the course of many cycles, according to an embodiment herein.

FIG. 7 shows the gravimetric capacity and Coulombic efficiency of a surface-treated negative electrode in a half cell with ether-based electrolyte, according to an embodiment herein.

FIG. 8 shows the capacity retention of a surface-treated negative electrode in a half cell with ether-based electrolyte normalized to the first discharge capacity at a C/5 rate (approximately 12-minute discharge), according to an embodiment herein.

FIG. 9 is back-scattered scanning electron microscopy images at 1000× and 5000× times magnification of the untreated lead foil surface, according to an embodiment herein.

FIG. 10 is back-scattered scanning electron microscopy images at 1000× and 5000× times magnification of the surface-treated lead surface, according to an embodiment herein.

FIG. 11 is energy dispersive X-ray spectra with scanning electron microscopy images of the surface-treated lead surface, according to an embodiment herein.

### DETAILED DESCRIPTION

Some embodiments of the present disclosure provide a new surface-treated negative electrode for use in sodium-ion batteries. Sodium-ion batteries are an alternative to lithium-based batteries. General parameters of sodium-ion batteries are disclosed in

https://onlinelibrary.wiley.com/doi/10.1002/cey2.464,
https://pubs.acs.org/doi/10.1021/cr500192f, and corresponding patents US20180287167A1, U.S. Pat. No. 10,916,771B2, and WO2024135593A1.

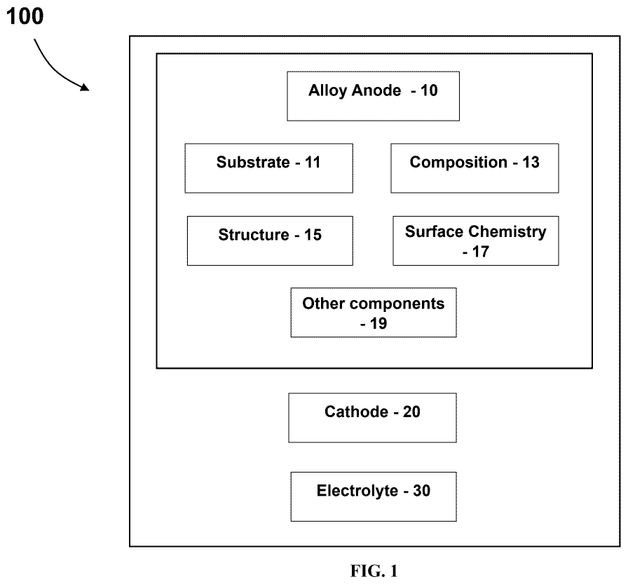

FIG. 1 is a schematic of a sodium-ion battery 100 according to embodiments. The sodium-ion batteries utilize an alloy anode negative electrode 10 which offers high volumetric capacity (e.g., Pb is 1072 mAh cm⁻³). The cathode 20 may be composed of a layered oxide, phosphate, Prussian-blue-derived compound, or conversion material, as non-limiting examples. An electrolyte composition 30 is provided.

The negative electrode 10 includes a substrate 11, active material composition 13, structure(s) 15, surface chemistry 17, and other components 19. The substrate 11 may consist of aluminum, copper, a carbon-based layer, or some combination of these, as non-limiting examples. The active material composition 13 may include a group 14 element or alloy, most plausibly lead (Pb), as 50-100 wt % of the total composition. The structure 15 may include a composite with inactive material(s) or a patterned or rolled foil, film or sheet.

The surface chemistry 17 consists of species and interphases that are more advantageous to charge transfer than the native passivation layer. Lead can form many oxides and carbonate when exposed to atmospheric conditions. The two dimorphous lead monoxide compositions have distinct tetragonal and orthorhombic lattices structures and are both poor electronic conductors with over four orders of magnitude lower electronic conductivity than lead metal. Various surface treatment methods can be adopted to eliminate and/or replace the native passivation layer with more beneficial species and interphases. A representative surface treatment process, acid etching is cheap and scalable for roll-to-roll manufacturing of sodium-ion batteries.

The surface treatment process generally includes an (1) acid etching step and may include a (2) washing step and/or (3) drying step. The washing agent for an acid etch with HCl should be dimethyl sulfoxide (DMSO) since one of the acid etch byproducts, lead chloride (PbCl₂), is not soluble in other conventional solvents. For other acid etching solution compositions, acetone is generally suitable as the washing solvent.

An acid etching solution for dictating surface chemistry 17 may be selected from the group consisting of hydrochloric acid (HCl), tetrafluoroboric acid (HBF₄), bis(fluorosulfonyl)imidic acid (HFSI), bis(trifluoromethanesulfonyl)imidic acid (HTFSI), trifluoromethanesulfonic acid (HOTf), acetic acid (HCH₃COO), hexafluorophosphic acid (HPF₆), perchloric acid (HClO₄), tetrafluoroboric acid (HBF₄), bis(oxalato)boric acid (HBOB), difluoro(oxalato)boric acid (HDFOB), sulfuric acid (H₂SO₄), nitric acid (HNO₃), hydrobromic acid, hydrofluoric acid, hydroiodic acid, and combinations thereof, for example.

Other acid compositions will correspond to particular redox reactions during the surface treatment process. Chemists will understand that classes of anions common to battery electrolytes (e.g., the imides TFSI, FSI, OTf) can be substituted to engineer the surface chemistry of the negative electrode.

An acid etching solution is generally 10% of concentrated acid by volume in aqueous media or at least 1 M.

In some embodiments, the acid etching step involves immersion of the active material in the acid etching solution for between 10 to 3000 seconds at 20 to 60 °C and 1 atm.

In some embodiments, the acid etching step involves agitation of the active material while in the acid etching solution by sonication or stirring.

In some embodiments, the washing agent is a single solvent or cleaning solution mixture selected from the group consisting of DMSO, acetone, isopropanol, ethanol, methanol, trichloroethylene, or water in some combination, as non-limiting examples.

In some embodiments, the washing step involves immersion of the active material in the washing solution for between 10 to 300 seconds at room temperature and 1 atm.

In some embodiments, the washing step involves agitation of the active material while in the acid etching solution by sonication or stirring.

In some embodiments, the drying step may involve a cleaning tissue, a squeegee, and/or dry nitrogen.

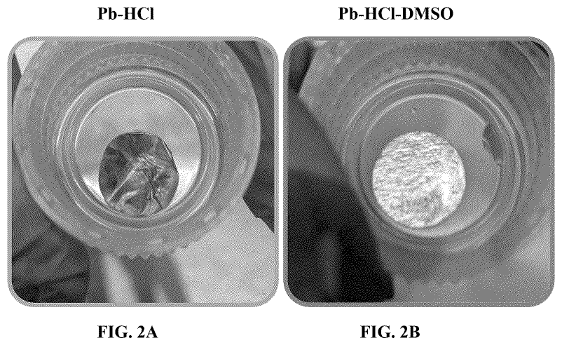

FIGS. 2A and 2B shows the change in luster of the alloy surface after successfully washing with DMSO after an acid etch with HCl.

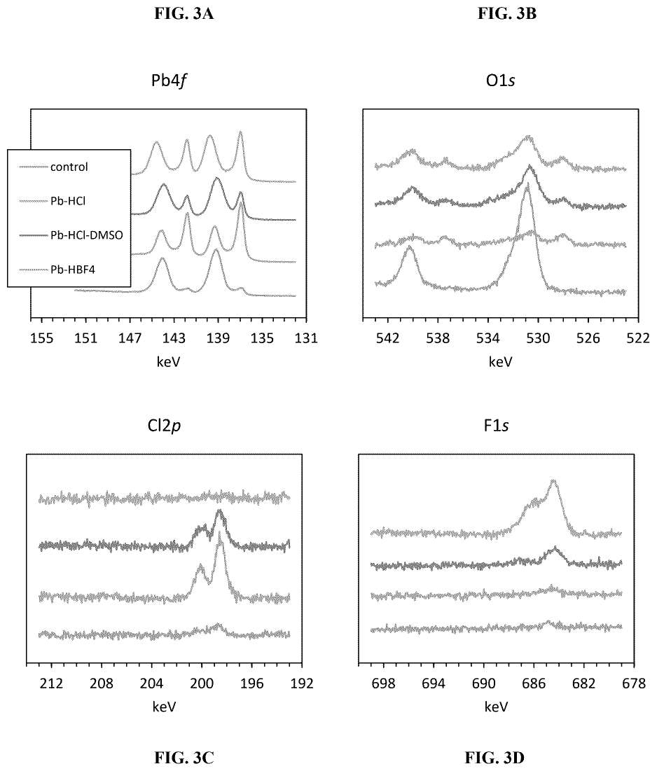

FIG. 3 indicates the change in surface chemistry 17 due to the various surface-treatment processes. In the untreated sample (green, bottom), the native oxide layer is dominated by PbOₓ and/or PbCO₃ species which cannot be deconvoluted and both overlap at a binding energy of around 139 eV in the Pb4f spectra. The corresponding oxide signal at 531 eV is strongest, by far, in the untreated sample. Negligible background levels of Cl2p and F1s are observed for the untreated sample. The surface treatment with only a HCl acid etch (orange, 2^{nd} from bottom) results in the lowest oxide signal and the highest Cl2p signal, associated with replacement of the native oxide layer with PbCl₂ formation. A sample that undergoes a HCl acid etch and is then washed in DMSO (blue, 2^{nd} from top) shows a unique surface chemistry with negligible native oxide, some lingering PbCl₂, and negligible DMSO residue, as evidenced from the O1s, Cl2p, and S2p bands, respectively. In the last sample, a surface treatment with HBF₄ acid without washing (pink, top) resulted in reduced native oxide signal and PbF₂ formation as noted in the O1s and F1s bands, respectively.

In all embodiments, the surface treatment process results in the emergence of a strong band in the Pb4f spectra associated with Pb metal, around 136.9 eV.

In some embodiments, the Pb metal band is strongest for a surface treatment process without a washing step. However, this also presents a tradeoff due to the formation of PbAₓ species, where A is derivative of the anion in the acid solution.

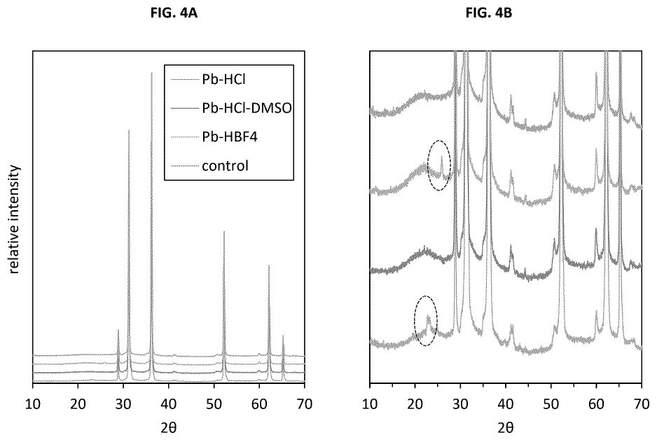

FIG. 4 shows the X-ray diffraction spectra for the same sample conditions as FIG. 3. The untreated sample shows Pb metal bands (top, green) without a significant signal from any other surface species. A similar spectrum is also collected for the Pb—HCl-DMSO sample, which lacks additional bands associated with the acid etch step and washing solution residue. The other two samples collected from acid-etched samples without a washing step each show a single faint peak between 20 to 30 degrees associated with the replacement of the native oxide layer with PbCl₂ or PbF₂, respectively. The faint nature of these bands indicates that the bulk composition of the negative electrode active material is unchanged.

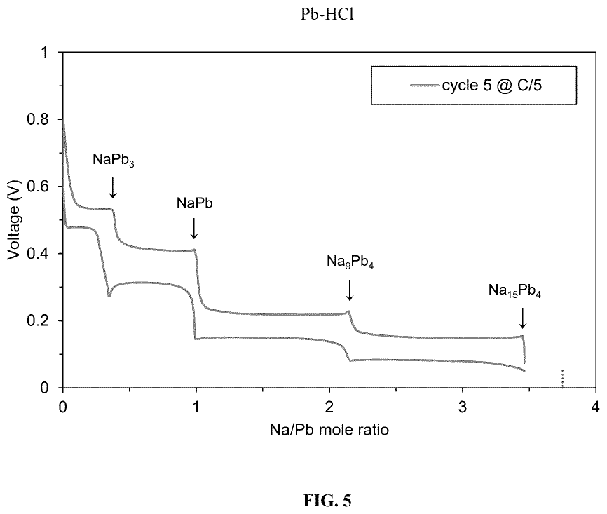

FIG. 5 shows the galvanostatic voltage profile of a surface-treated sample Pb—HCl that achieves over 90% of the theoretical capacity of the active material in the 5^{th} cycle, after formation. In contrast, an untreated sample is unable to cycle with any appreciable capacity as confirmed by Zhang and colleagues in a recent publication (doi: 10.1149/1945-7111/ad76e0). Achieving over 90% of the theoretical capacity of the negative electrode corresponds to over 90% utilization of the active material and is a critical threshold to commercial viability of a negative electrode material. Substantial amounts in inactive material result in reduced energy density.

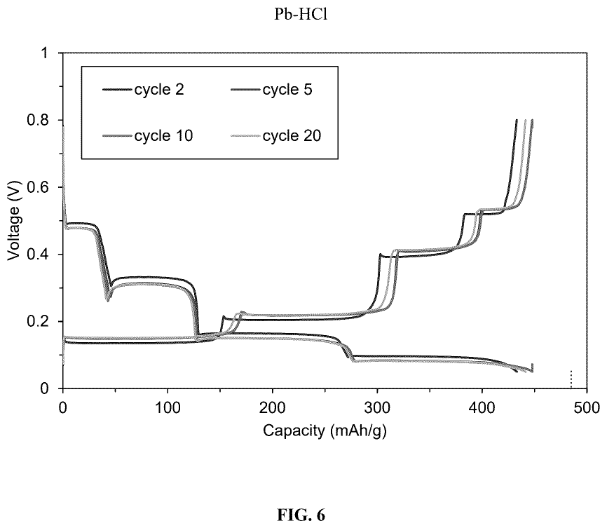

FIG. 6. shows the voltage profile of a surface-treated negative electrode for select cycles. The voltage profile shows an increase in capacity due to better utilization of active material for the NaPb to Na₉Pb₄ alloying reaction, but a corresponding increase in overpotential associated with the change in rate from C/20 to C/5.

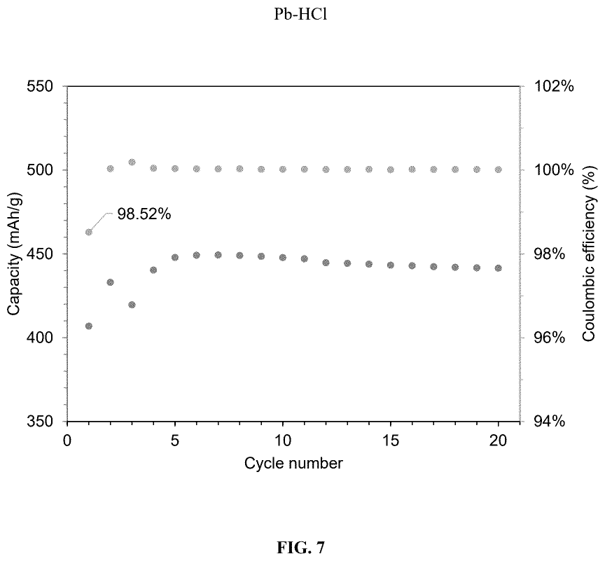

FIG. 7 shows the gravimetric capacity and Coulombic efficiency of the active material in a surface-treated lead negative electrode in a half-cell. Experiments indicate that the initial Coulombic efficiency of the surface-treated negative electrode is 98.52% with a subsequent Coulombic efficiency of around unity (100%). These Coulombic efficiency values are critical to the commercial viability of the negative electrode material. An average Coulombic efficiency above 99.95% is needed to avoid consuming solute, or more catastrophically, drying out the cell and losing over 10% of capacity after just 200 cycles. The high initial efficiency of the surface-treated negative electrode is particularly appealing relative to the state-of-the-art hard carbon negative electrode material which achieves only 77% initial Coulombic efficiency.

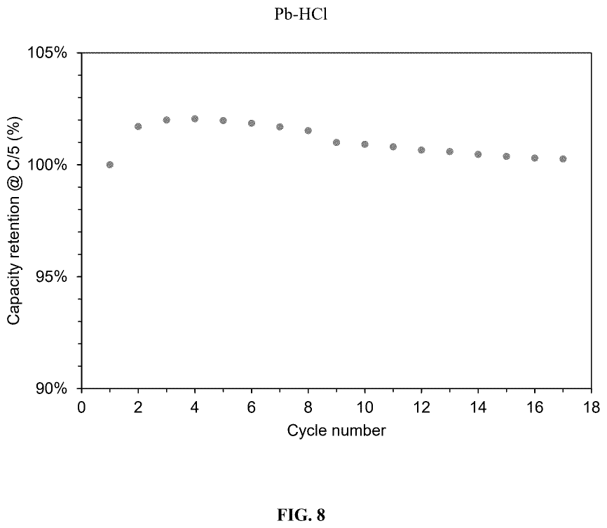

FIG. 8 shows a half-cell with the surface-treated negative electrode has negligible capacity loss while cycling at C/5.

Using the surface-treated negative electrode with conventional electrolytes is infeasible due to the catalytic reactivity of the alloy material (i.e. Pb or Sn) with various solvents and additive molecules. For instance, cyclic, linear, and fluorinated carbonates react with the group 14 elements to the detriment of cell performance. Esters also catalytically decompose to the detriment of cell performance. Phosphate solvents do not provide suitable performance.

Ethers are a suitable solvent class for the liquid electrolyte(s) 30 with the surface-treated negative electrode for sodium-ion batteries. NaPF₆ is a suitable solute for cell performance.

In some embodiments, small amounts of FEC or other SEI-forming additives (≤2 wt %) can be leveraged in ether-based electrolytes without compromising performance.

In some embodiments, cosolvents can be used to improve the reversibility and voltage stability of the electrolyte for sodium-ion batteries with the surface-treated negative electrode.

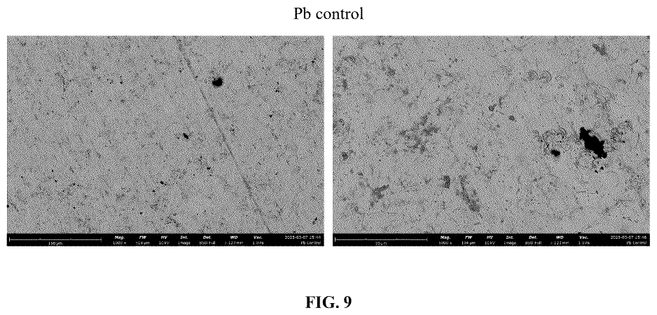

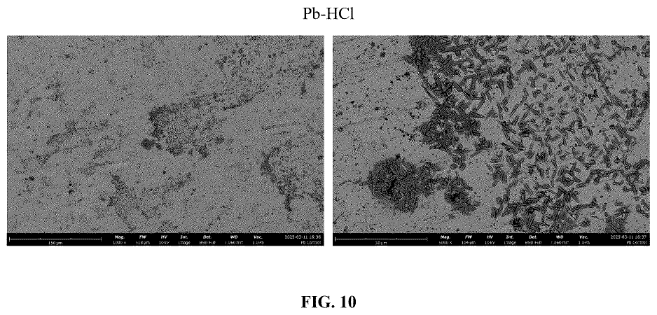

FIGS. 9 and 10 show the morphology and structure of the surface-treated negative electrode. In some embodiments, the structure(s) 15 is a rolled or patterned foil, film or sheet. The structure can also be composite or laminate.

In some embodiments, there is a small amount of mass loss (<1 wt %) due to the surface treatment process which is not recovered by incorporating a washing step. The acid etch duration correlates to the mass loss.

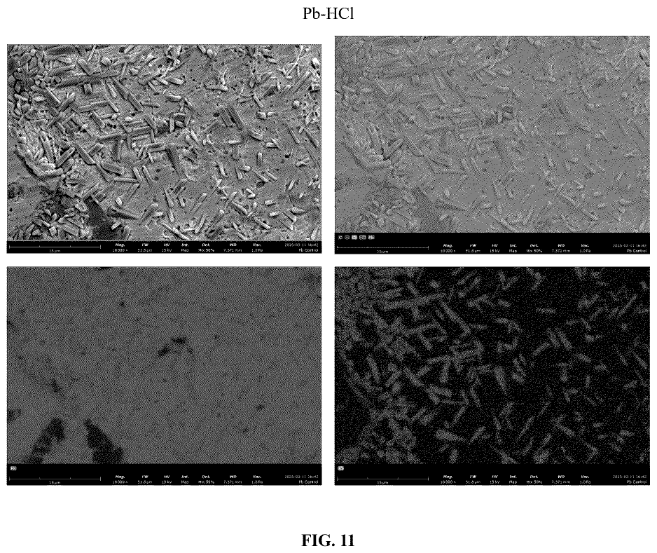

FIG. 11 is energy dispersive X-ray spectra overlaid on scanning electron microscopy images which show the chemical and morphological changes, respectively, to the surface-treated negative electrode due to surface treatment process. The surface-treated negative electrode has deposits of PbCl₂ crystals which are not evident on the untreated and washed samples.

The present embodiment enables major improvements in cycle life and efficiency compared to state of-the-art negative electrodes for sodium-ion electrolytes. Coulombic efficiencies above 99% are feasible with a 20% improvement in initial Coulombic efficiency relative to hard carbon active materials. These metrics represent a huge step toward commercially viable sodium-ion metal batteries. Additionally, the surface treatment process is straightforward as evidenced from the present disclosure.

This technology is appealing for commercial applications because it enables a plentiful crude material, and it addresses a key challenge (native oxide layer) associated with alloy negative electrodes for sodium-ion metal batteries. Importantly, the surface treatment process can be used in combination with other preparation processes, negative electrode structures, and electrolyte innovations for distinct and correlative effects, resulting in substantial improvements to performance.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to practice the various embodiments herein with various modifications as may be suited to the particular use contemplated.

The foregoing description of the specific embodiments will so fully reveal the general nature of the embodiments herein that others may, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein may be practiced with modification within the spirit and scope of the appended claims.

What is claimed is:

1. A sodium-ion battery cell comprising:
a negative electrode comprising an active material, wherein the active material comprises a group 14 metal or an alloy thereof, and wherein the active material has a surface chemistry defined by a surface treatment process configured to remove a native oxide layer thereon;
a positive electrode; and
an electrolyte comprising an ether-based solvent.

2. The sodium-ion battery cell of claim 1, wherein the group 14 metal is lead (Pb).

3. The sodium-ion battery cell of claim 1, wherein the active material comprises a rolled or patterned foil, film or sheet having at least 50% by weight of lead (Pb).

4. The sodium-ion battery cell of claim 1, wherein the surface treatment process comprises an acid etching step.

5. The sodium-ion battery cell of claim 4, wherein the acid etching step uses an acid solution including hydrochloric acid (HCl), tetrafluoroboric acid (HBF₄), bis(fluorosulfonyl)imidic acid (HFSI), bis(trifluoromethanesulfonyl)imidic acid (HTFSI), trifluoromethanesulfonic acid (HOTf), acetic acid (HCH₃COO), hexafluorophosphic acid (HPF6), perchloric acid (HClO4), bis(oxalato)boric acid (HBOB), difluoro(oxalato)boric acid (HDFOB), sulfuric acid (H2SO4), nitric acid (HNO3), hydrobromic acid, hydrofluoric acid, hydroiodic acid, and combinations thereof.

6. The sodium-ion battery cell of claim 4, wherein the surface of the active material, after the surface treatment process, comprises a lead halide species.

7. The sodium-ion battery cell of claim 4, wherein the surface treatment process further comprises a washing step after the acid etching step.

8. The sodium-ion battery cell of claim 7, wherein the surface treatment process further comprises a drying step involving a cleaning tissue and/or dry nitrogen.

9. The sodium-ion battery cell of claim 7, wherein the washing step comprises a washing solution of dimethyl sulfoxide (DMSO) and the acid etching step utilizes hydrochloric acid (HCl).

10. The sodium-ion battery cell of claim 7, wherein the washing step is at least 10 and no more than 300 seconds long.

11. The sodium-ion battery cell of claim 1, wherein the positive electrode is selected from a group consisting of: layered oxide, phosphate, Prussian-blue-derived compounds, or a conversion material.

12. The sodium-ion battery cell of claim 1, wherein the electrolyte further comprises an SEI-forming additive at a concentration of less than or equal to 2% by weight.

13. A method for manufacturing a negative electrode for a sodium-ion battery, the method comprising:
providing an active material comprising a group 14 element or an alloy thereof, the active material having a native oxide layer; and
applying a surface treatment to the active material, the surface treatment comprising an acid etching step wherein the active material is immersed in an acid etching solution for a predetermined duration to remove at least a portion of the native oxide layer.

14. The method of claim 13, wherein the active material comprises a rolled or patterned foil, film or sheet having at least 50% by weight of lead (Pb).

15. The method of claim 13, wherein the predetermined duration is between 10 and 3000 seconds.

16. The method of claim 13, wherein the acid etching step is performed at a temperature between 20 °C and 60 °C.

17. The method of claim 13, wherein the acid etching step further comprises agitating the active material while in the acid etching solution.

18. The method of claim 13, wherein the acid etching solution has an acid concentration of at least 1 M.

19. The method of claim 13, wherein the acid etching solution comprises an acid selected from the group consisting of hydrochloric acid (HCl), tetrafluoroboric acid (HBF4), bis(fluorosulfonyl)imidic acid (HFSI), bis(trifluoromethanesulfonyl)imidic acid (HTFSI), and trifluoromethanesulfonic acid (HOTf).

20. The method of claim 13, further comprising a washing step after the acid etching step, wherein the active material is immersed in a washing solution comprising dimethyl sulfoxide (DMSO).
